(19) United States
(12) Patent Application Publication
(10) Pub. No.: US 2026/0237154 A1
(43) Pub. Date: Aug. 13, 2026

(54) IMAGE PROCESSING METHOD AND APPARATUS, ELECTRONIC DEVICE, AND STORAGE MEDIUM

(71) Applicants: Beijing Zitiao Network Technology Co., Ltd., Beijing (CN); Zhejiang University, Hangzhou City (CN)

(72) Inventors: Zesong YANG, Beijing (CN); Bangbang YANG, Beijing (CN); Yuewen MA, Beijing (CN); Zhaopeng CUI, Hangzhou City (CN)

(21) Appl. No.: 19/534,019

(22) Filed: Feb. 9, 2026

(30) Foreign Application Priority Data
Feb. 8, 2025 (CN) 202510141377.7

(51) Int. Cl. G06T 17/00; G06T 5/50; G06T 5/70; G06T 15/20; G06V 10/26; G06V 10/762; G06V 10/77; G06V 10/774

(52) U.S. Cl. CPC G06T 17/00; G06T 5/50; G06T 5/70; G06T 15/20; G06V 10/26; G06V 10/762; G06V 10/7715; G06V 10/774; G06T 2207/10028; G06T 2207/20081; G06T 2207/20224; G06T 2210/56

(57) ABSTRACT

The present disclosure provides an image processing method and apparatus, an electronic device, and a storage medium. The image processing method includes: acquiring a plurality of first images, which are images of a first scene from different viewpoints; performing two-dimensional instance segmentation on an instance in the first image to obtain a plurality of two-dimensional masks; back-projecting the two-dimensional masks onto the three-dimensional Gaussian point cloud; clustering the respective two-dimensional masks according to a spatial relationship of the three-dimensional Gaussian point cloud; assigning a feature to the respective Gaussian points using a pre-trained feature field; segmenting the Gaussian points by the instance to which the Gaussian points belong according to a clustering result of the two-dimensional masks and the feature of the respective Gaussian points; and generating a three-dimensional model of the instance according to the segmented three-dimensional Gaussian point cloud.

### CROSS-REFERENCE TO RELATED APPLICATION(S)

This application claims priority to Chinese Application No. 202510141377.7 filed Feb. 8, 2025, the disclosure of which is incorporated herein by reference in its entity.

### FIELD

The present disclosure relates to the field of computer technologies, and in particular, to an image processing method and apparatus, an electronic device, and a storage medium.

### BACKGROUND

The technique of generating three-dimensional models from images is widely used in computer-related fields such as virtual reality. The process of three-dimensional reconstruction from images of real scenes is usually to reconstruct a scene as a whole model, while finer downstream tasks, such as scene editing, object grasping, etc., require object-level model reconstruction.

### SUMMARY

The present disclosure provides an image processing method and apparatus, an electronic device, and a storage medium.

The present disclosure adopts the following technical solutions.

In some embodiments, the present disclosure provides an image processing method, including:
acquiring a plurality of first images, where the plurality of first images are images of a first scene from different viewpoints, the first scene corresponds to a three-dimensional Gaussian point cloud generated according to the first images, and the three-dimensional Gaussian point cloud includes a plurality of Gaussian points;
performing two-dimensional instance segmentation on an instance in the first image to obtain a plurality of two-dimensional masks;
back-projecting the two-dimensional masks onto the three-dimensional Gaussian point cloud;
clustering the respective two-dimensional masks according to a spatial relationship of the three-dimensional Gaussian point cloud, where respective the two-dimensional masks corresponding to a same instance are clustered together;
assigning a feature to the respective Gaussian points using a pre-trained feature field;
segmenting the Gaussian points by the instance to which the Gaussian points belong according to a clustering result of the two-dimensional masks and the feature of the respective Gaussian points; and
generating a three-dimensional model of the instance according to the segmented three-dimensional Gaussian point cloud;
where the three-dimensional model includes a missing part of the instance that is not displayed in the first image.

In some embodiments, the present disclosure provides an image processing apparatus, including:
an acquiring unit, configured to acquire a plurality of first images, where the plurality of first images are images of a first scene from different viewpoints, the first scene corresponds to a three-dimensional Gaussian point cloud generated according to the first images, and the three-dimensional Gaussian point cloud includes a plurality of Gaussian points; and
a control unit, configured to perform two-dimensional instance segmentation on an instance in the first image to obtain a plurality of two-dimensional masks;
where the control unit is configured to back-project the two-dimensional masks onto the three-dimensional Gaussian point cloud;
the control unit is configured to cluster the respective two-dimensional masks according to a spatial relationship of the three-dimensional Gaussian point cloud, where the respective two-dimensional masks corresponding to a same instance are clustered together;
the control unit is configured to assign a feature to the respective Gaussian points using a pre-trained feature field;
the control unit is configured to segment the Gaussian points by the instance to which the Gaussian points belong according to a clustering result of the two-dimensional masks and the feature of the respective Gaussian points;
the control unit is configured to generate a three-dimensional model of the instance according to the segmented three-dimensional Gaussian point cloud; and
where the three-dimensional model includes a missing part of the instance that is not displayed in the first image.

In some embodiments, the present disclosure provides an electronic device, including: at least one memory and at least one processor;
where the memory is configured to store program code, and the processor is configured to call the program code stored in the memory to perform the above method.

In some embodiments, the present disclosure provides a computer-readable storage medium, the computer-readable storage medium is configured to store program code, and the program code, when run by a processor, causes the processor to perform the above method.

### BRIEF DESCRIPTION OF THE DRAWINGS

The above and other features, advantages and aspects of various embodiments of the present disclosure will become more apparent when taken in conjunction with the drawings and with reference to the following detailed description. Throughout the drawings, the same or similar reference numbers refer to the same or similar elements. It should be understood that the drawings are schematic and that elements and elements are not necessarily drawn to scale.

FIG. 1 is a flowchart of an image processing method according to an embodiment of the present disclosure.

FIG. 2 is a schematic diagram of a first image, a Gaussian point cloud, an incomplete three-dimensional model and a complete three-dimensional model according to an embodiment of the present disclosure.

FIG. 3 is a schematic diagram of an image processing method according to an embodiment of the present disclosure.

FIG. 4 is a schematic diagram of generating a conditional image and a second image according to an embodiment of the present disclosure.

FIG. 5 is a structural schematic diagram of an electronic device according to an embodiment of the present disclosure.

### DETAILED DESCRIPTION OF EMBODIMENTS

It may be understood that before using the technical solutions disclosed in the embodiments of the present disclosure, the user shall be informed of the type, range of use, use scenarios, etc. of personal information involved in the present disclosure and obtain the authorization of the user in an appropriate manner in accordance with relevant laws and regulations.

For example, in response to receiving an active request from a user, prompt information is sent to the user to clearly prompt the user that the requested operation will require access to and use of the user's personal information. As such, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to select whether to “agree” or “disagree” to provide the personal information to the electronic device.

It may be understood that the above process of notifying and obtaining user authorization is only illustrative and does not limit the implementations of the present disclosure, and other methods that satisfy the relevant laws and regulations may also be applied in the implementations of the present disclosure.

It may be understood that the data involved in the technical solution (including but not limited to the data itself, acquisition or use of the data) shall comply with the requirements of corresponding laws, regulations and related provisions.

The embodiments of the present disclosure will be described in more detail below with reference to the drawings. Although certain embodiments of the present disclosure are shown in the drawings, it should be understood that the present disclosure may be implemented in various forms and should not be construed as limited to the embodiments set forth herein. Rather, these embodiments are provided for a thorough and complete understanding of the present disclosure. It should be understood that the drawings and embodiments of the present disclosure are only used for exemplary purposes, and are not used to limit the protection scope of the present disclosure.

It should be understood that various steps described in method implementations of the present disclosure may be performed sequentially and/or in parallel. Furthermore, the method implementations may include additional steps and/or omit performing illustrated steps. The scope of the present disclosure is not limited in this respect.

The term “include/comprise” and variations thereof used herein are open-ended inclusions, that is, “include/comprise but not limited to”. The term “based on” is “based at least in part on”. The term “an embodiment” means “at least one embodiment”; the term “another embodiment” means “at least one other embodiment”; the term “some embodiments” means “at least some embodiments”. Relevant definitions of other terms will be given in the description below.

It should be noted that concepts such as “first” and “second” mentioned in the present disclosure are only used to distinguish different apparatuses, modules or units, and are not used to limit the order of functions performed by these apparatuses, modules or units or interdependence therebetween.

It should be noted that the modification of “a” mentioned in the present disclosure is illustrative and not restrictive, and those skilled in the art should understand that unless clearly indicated in the context, it should be understood as “one or more”.

The names of messages or information exchanged between multiple apparatuses in the implementations of the present disclosure are only used for illustrative purposes, and are not used to limit the scope of these messages or information.

The solutions provided by the embodiments of the present disclosure will be described in detail below with reference to the drawings.

The technique of generating three-dimensional models from images is widely used in various fields. By taking images of a scene (including objects in the scene) from different angles, a three-dimensional model of (the objects in) the scene is generated. However, the generated three-dimensional model is often a whole, and finer tasks require object-level model reconstruction.

Regarding the problem of decoupling and completely reconstructing objects in a scene, on the one hand, the existing methods of decoupling objects and reconstructing models in a scene usually only support a few categories, or still require manual intervention such as manual segmentation, and cannot achieve decoupling and reconstruction of general categories (arbitrary objects). On the other hand, due to occlusions in a complex environment and limitations of shooting angles, the reconstruction results of objects are often incomplete, which further limits the applications of the reconstruction results.

According to the image processing method provided by the embodiments of the present disclosure, by means of back-projecting the two-dimensional masks onto the three-dimensional Gaussian point cloud, the two-dimensional masks of the first images having content intersection with each other are clustered using the spatial relationship of the three-dimensional Gaussian point cloud, and the clustering result is used to help segment the Gaussian points, thereby determining the instance to which each Gaussian point belongs, realizing decoupling of non-limited instances, and further facilitating generation and completion of the three-dimensional model of the instance.

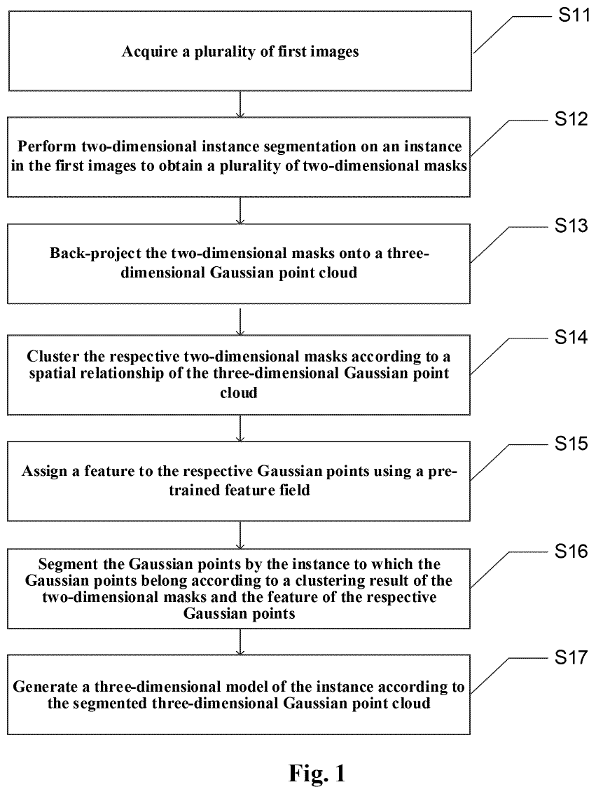

As shown in FIG. 1, FIG. 1 is a flowchart of an image processing method according to an embodiment of the present disclosure, including the following steps.
S11: a plurality of first images are acquired.

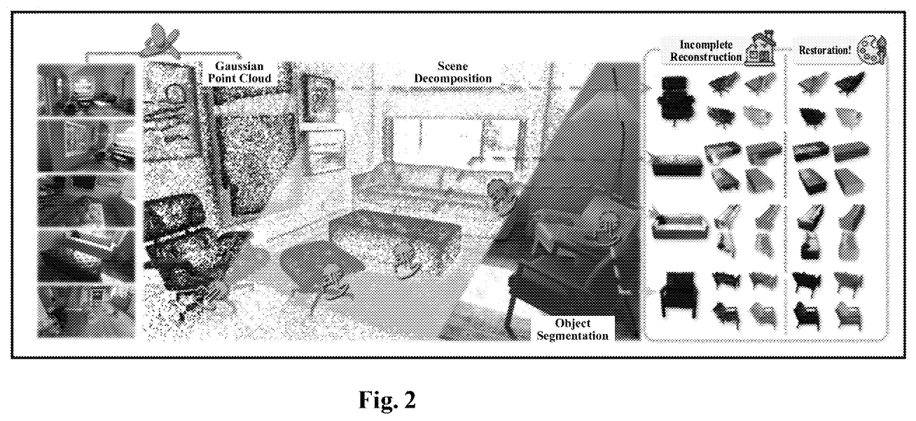

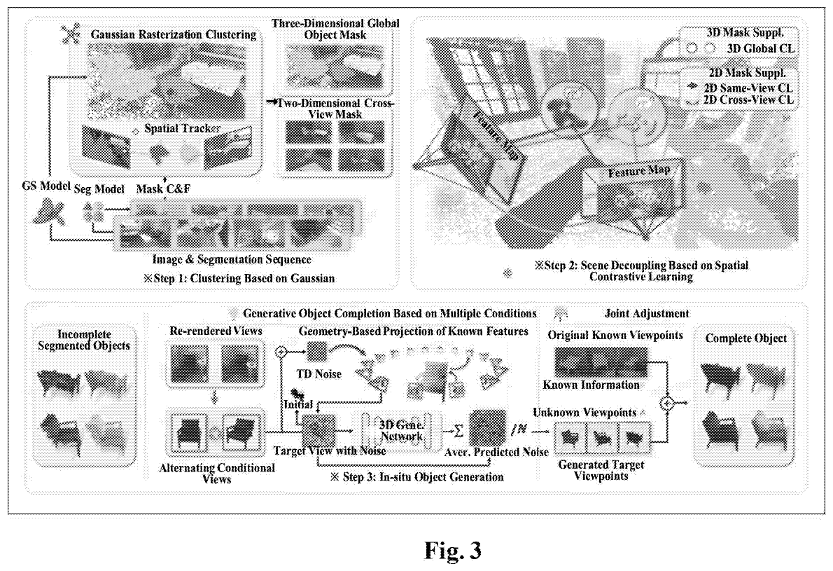

In some embodiments, the plurality of first images are images of a first scene from different viewpoints, and the first scene includes an instance, which may be an object in the first scene. As shown in FIG. 2, the five leftmost images are first images, the first scene is a room, and the sofa, chairs, coffee table, etc. in the room are instances. The first scene corresponds to a three-dimensional Gaussian point cloud generated according to the first images, and the three-dimensional Gaussian point cloud includes a plurality of Gaussian points. The three-dimensional Gaussian point cloud corresponding to the first scene is specifically a sum of three-dimensional Gaussian point clouds of respective instances. However, the three-dimensional Gaussian point cloud corresponding to the first scene is not segmented according to the instance corresponding to each Gaussian point, and thus it is often impossible to directly distinguish which instance each Gaussian point belongs to (or corresponds to). In FIG. 3, what is located above the “image & segmentation sequence” in the “step 1: clustering based on Gaussian” is the first image.
S12: the two-dimensional instance segmentation is performed on the instance in the first image to obtain a plurality of two-dimensional masks.

In some implementations, a two-dimensional instance segmentation (EntitySeg) is used to obtain an object-level segmentation mask of a scene, and there are a plurality of first images, with each first image corresponding to one two-dimensional mask map. The two-dimensional mask map may usually be displayed as an image corresponding to the first image, and a plurality of two-dimensional masks are displayed in the two-dimensional mask map (in an ideal condition, one instance corresponds to one two-dimensional mask in the two-dimensional mask map, but in an actual condition, there is a case of under-segmentation, and there is a case where two-dimensional masks corresponding to two adjacent instances are regarded as one two-dimensional mask). The two-dimensional mask is displayed as a sheet-like region corresponding to a shape of the instance in the two-dimensional mask map, and two-dimensional masks of different instances are usually displayed in different colors. The region corresponding to the instance in the first image may be distinguished by the two-dimensional mask. In FIG. 3, the image pointed to by the arrow on the right side of the “segmentation model (Seg Model)” (located below the “mask clustering & filtering (Mask C&F)” and partially occluded by the first image) is the two-dimensional mask map. The same instance corresponds to two-dimensional masks in different two-dimensional mask maps, but it cannot be directly determined whether the two-dimensional masks in different two-dimensional mask maps correspond to the same instance. For example, it cannot be determined whether a certain two-dimensional mask in the two-dimensional mask map A and a certain two-dimensional mask in the two-dimensional mask map B are two-dimensional masks of the same instance. Therefore, the subsequent step is executed to cluster the two-dimensional masks. Moreover, the segmentation result of the two-dimensional mask cannot be directly used to guide feature learning due to the problems of inconsistency among a plurality of images and severe noise interference in a complex scene. The segmentation result of the two-dimensional mask is relatively rough, and there may be some cases where the segmentation is unreliable.
S13: the two-dimensional masks are back-projected onto the three-dimensional Gaussian point cloud.

In some embodiments, based on the rasterization of Gaussian splatting (GS), each two-dimensional mask is back-projected into the three-dimensional space, so that the Gaussian point onto which the two-dimensional mask is projected may be determined.
S14: the respective two-dimensional masks are clustered according to a spatial relationship of the three-dimensional Gaussian point cloud.

In some embodiments, the spatial relationship of the three-dimensional Gaussian point cloud is used to implement matching of the two-dimensional mask maps of the plurality of first images, that is, the two-dimensional masks corresponding to the same instance are clustered together, so that it may be determined which of the two-dimensional masks in the two-dimensional mask maps corresponding to each of the first images correspond to the same instance. In the steps of some embodiments, the two-dimensional masks corresponding to each instance are determined, and because one instance may exist in different first images, one instance may correspond to a plurality of two-dimensional masks, which are distributed in different two-dimensional mask maps. The two-dimensional masks corresponding to one instance in each of the two-dimensional mask maps may be determined by clustering.
S15: a feature to is assigned the respective Gaussian points using a pre-trained feature field.

In some embodiments, not all Gaussian points may be well projected onto the two-dimensional masks, and the instance corresponding to each Gaussian point cannot be directly distinguished only by the two-dimensional masks. However, the clustering result of the two-dimensional masks provides a priori knowledge, that is, the correspondence between some Gaussian points and the instance is determined, which may help determine whether the remaining Gaussian points are Gaussian points of the same instance. Before determining whether each Gaussian point belongs to the same instance, a feature field is pre-trained, and the first image and the three-dimensional Gaussian point cloud are input into the feature field. The feature field assigns a feature to each Gaussian point in the three-dimensional Gaussian point cloud, where the feature field is pre-trained to make the difference between the features of the Gaussian points corresponding to the same instance small and the difference between the Gaussian points corresponding to different instances large, thereby being capable of distinguishing whether each Gaussian point corresponds to the same instance.
S16: the Gaussian points are segmented by the instance to which the Gaussian points belong according to a clustering result of the two-dimensional masks and the feature of the respective Gaussian points.

In some embodiments, the clustering result of the two-dimensional masks shows the two-dimensional masks corresponding to each instance, and it may be known which Gaussian points correspond to the instance by back-projecting onto the three-dimensional Gaussian point cloud. However, some Gaussian points corresponding to the instance may be omitted. For any instance, the Gaussian points corresponding to the instance may be determined by the clustered two-dimensional masks corresponding to the instance, and then the mean value of the features of these Gaussian points is determined. The mean value represents the average feature of the Gaussian points corresponding to the instance. The cosine similarity between the feature of another Gaussian point and the mean value is calculated, and if the cosine similarity reaches a threshold value, such as 0.9, it may be considered that the other Gaussian point corresponds to the instance, that is, belongs to the instance (see the object segmentation in FIG. 2).
S17: a three-dimensional model of the instance is generated according to the segmented three-dimensional Gaussian point cloud.

In some embodiments, it may be impossible to completely photograph all parts of the instance in the first image. For example, if the instance is a table, a certain table leg of the table may not be photographed in all first images, that is, the table leg is a missing part not shown in the first image. In some embodiments, the Gaussian points corresponding to each instance may be determined in the segmented three-dimensional Gaussian point cloud (these Gaussian points form an incomplete model of the instance, see the model below the “incomplete reconstruction” in FIG. 2), and the missing part may be simulated using a diffusion network in combination with the known Gaussian points of the instance, and then a complete three-dimensional model of the instance is generated (see the model below the “restoration” in FIG. 2), that is, the generated three-dimensional model includes the missing part of the instance that is not shown in the first image. After the three-dimensional model of the instance is generated, the instances in the first scene may be rearranged, the position and orientation of the instance may be changed, and an image of the rearranged first scene may be generated.

In some embodiments of the present disclosure, a solution is proposed that is capable of decoupling a scene represented by Gaussian splatting into object-level (instance-level) scene reconstruction with complete geometry and appearance. The non-limited category of objects in the first scene may be segmented, and at the same time, the missing part of the objects may be reasonably repaired based on the segmentation result, which may be further used to support rearrangement and interaction of the objects, thereby realizing reconstruction of a real-world environment with decoupled objects. Specifically, in some embodiments of the present disclosure, by means of back-projecting the two-dimensional masks onto the three-dimensional Gaussian point cloud, the two-dimensional masks of the first images having content intersection with each other are clustered using the spatial relationship of the three-dimensional Gaussian point cloud, and the clustering result is used to help segment the Gaussian points, thereby determining the instance to which each Gaussian point belongs, realizing decoupling of fine-grained non-limited instances of the scene, and further facilitating generation and padding of the three-dimensional model of the instance.

In some embodiments of the present disclosure, the clustering the two-dimensional masks according to the spatial relationship of the three-dimensional Gaussian point cloud includes: determining a spatial tracker corresponding to each of the two-dimensional masks of each of the first images; and determining whether different two-dimensional masks belong to a same instance according to the spatial tracker, thereby clustering the two-dimensional masks; where the spatial tracker corresponding to the two-dimensional mask of the first image includes: a set of Gaussian points that participate in rasterization of a pixel corresponding to the two-dimensional mask in the first image and have transparency exceeding a first threshold.

In some embodiments, the two-dimensional masks in the two-dimensional mask maps of the plurality of first images may roughly distinguish the display range (contour) of each instance in one first image. However, there are problems of inconsistency among the plurality of first images (it cannot be determined whether the two-dimensional masks in the two-dimensional mask maps of different first images correspond to the same instance), and severe noise interference and insufficient recognition accuracy in a complex scene, so the two-dimensional masks cannot be directly used to guide the learning of the feature of the Gaussian points. Therefore, in some embodiments, a reliable two-dimensional mask clustering method is designed based on the spatial tracker to obtain the clustering result of the two-dimensional masks of the first images. Specifically, in the present embodiment, based on the rasterization of Gaussian splatting, after back-projecting each two-dimensional mask back to the three-dimensional Gaussian point cloud, the spatial relationship of the corresponding three-dimensional Gaussian point cloud is used to implement the clustering of the two-dimensional masks of the intersecting first images. First, it is necessary to determine the spatial tracker corresponding to each two-dimensional mask, and the spatial tracker is a set of some Gaussian points (see the “spatial tracker” in FIG. 3), specifically a set of Gaussian points that participate in the rasterization of the pixel corresponding to the two-dimensional mask in the first image and have transparency exceeding the first threshold. For example, taking the first threshold being 0.5 as an example, for a given first image Iᵢ (I represents the first image, and i is used to distinguish a specific first image), the corresponding two-dimensional instance segmentation result is represented as Mᵢ, and if a certain Gaussian point participates in the rasterization of the pixel corresponding to a certain two-dimensional mask m_{i,j} (m represents the two-dimensional mask, and i, j are used to distinguish a specific two-dimensional mask) in Ii and has transparency exceeding 0.5, it is considered that the Gaussian point belongs to the spatial tracker P_{i,j} (P represents the spatial tracker, and i, j are used to distinguish a specific spatial tracker) of the two-dimensional mask m_{i,j}, and therefore the spatial tracker includes a plurality of Gaussian points. The spatial tracker is used to determine whether each two-dimensional mask corresponds to the same instance (the two-dimensional masks clustered together correspond to the same instance, but there may be under-segmented two-dimensional masks that cannot be clustered).

In some embodiments of the present disclosure, the determining whether different two-dimensional masks belong to the same instance according to the spatial tracker includes determining whether any two two-dimensional masks belong to the same instance by using the following method: determining a consistency rate between a first spatial tracker and a second spatial tracker; and determining that the first spatial tracker and the second spatial tracker belong to the same instance in response to the consistency rate being greater than a second threshold; where the first spatial tracker and the second spatial tracker are spatial trackers respectively corresponding to any two two-dimensional masks; the consistency rate is equal to a ratio of a number of shared containing images of the first spatial tracker and the second spatial tracker to a number of shared visible images of the first spatial tracker and the second spatial tracker; if at least a first preset proportion of Gaussian points in a spatial tracker participate in rasterization of a pixel of another first image, and the other first image is different from the first image from which the two-dimensional mask corresponding to the spatial tracker comes, the other first image is a visible image of the spatial tracker; if at least a second preset proportion of Gaussian points in a spatial tracker appear in another spatial tracker, the first image from which the two-dimensional mask corresponding to the other spatial tracker comes is a containing image of the spatial tracker, and the first image from which the two-dimensional mask corresponding to the other spatial tracker originates is different from the first image from which the two-dimensional mask corresponding to the spatial tracker comes; and the second threshold is not less than 0.8 and less than 1, the second preset proportion is greater than the first preset proportion, and the second preset proportion is greater than 50%.

In some embodiments, in order to determine whether any two two-dimensional masks belong to the same instance, a consistency-based determination manner is proposed in the present disclosure. Specifically, the following definitions are first made: if at least a first preset proportion (for example, 30%) of Gaussian points in the spatial tracker P_{i,j} of the two-dimensional mask m_{i,j} of the first image Iᵢ participate in the rasterization of another first image I_{i′}, it is considered that P_{i,j} is visible in the other first image I_{i′}, and the other first image I_{i′} is a visible image of P_{i,j}. If at least a second preset proportion (for example, 80%) of Gaussian points in the spatial tracker P_{i,j} of the two-dimensional mask m_{i,j} of the first image Ii appear in another spatial tracker P_{i″, j″}, it is considered that P_{i,j} is contained by the first image I_{i″}, the first image I_{i″} is a containing image of P_{i,j}, and the other spatial tracker P_{i″,j″} is the spatial tracker of the two-dimensional mask of the first image I_{i″}. The spatial trackers corresponding to any two given two-dimensional masks are denoted as a first spatial tracker and a second spatial tracker. Then, a ratio C is obtained by dividing the number of shared containing images by the number of shared visible images, and the shared containing images are containing images of both the first spatial tracker and an image contained in the second spatial tracker. The shared visible images are visible images of both the first spatial tracker and the second spatial tracker. The ratio C is compared with a second threshold (for example, 0.9) as the consistency rate. If the consistency rate C exceeds the second threshold, it is considered that the two two-dimensional masks determined this time belong to the same instance. In the present embodiment, the clustering of the two-dimensional masks of different first images is achieved through the visible and containment relationship of the spatial tracker.

In some embodiments of the present disclosure, if a spatial tracker has the same Gaussian points as at least two other spatial trackers, and the spatial tracker always participates in the rasterization of the pixels of the visible images of the at least two other spatial trackers, and the first image from which the two-dimensional mask corresponding to the spatial tracker comes is different from the first image from which the two-dimensional masks corresponding to the at least two other spatial trackers come, and the two-dimensional masks corresponding to the at least two other spatial trackers come from the same first image, the two-dimensional mask corresponding to the spatial tracker is discarded.

In some embodiments, the two-dimensional mask may be under-segmented, and in this case, the two-dimensional masks of different instances are mistaken for the two-dimensional masks of the same instance. Therefore, the spatial tracker of such an under-segmented two-dimensional mask intersects with the spatial trackers of at least two other two-dimensional masks from another first image. That is, if the spatial tracker P_{i,j} associated with the two-dimensional mask m_{i,j} from the first image Iᵢ intersects with a plurality of spatial trackers from another first image Iₖ (has common Gaussian points), and the spatial tracker P_{i,j} is always visible in the visible images of the plurality of spatial trackers of the other first image Iₖ (that is, the spatial tracker P_{i,j} participates in the rasterization of the pixels of the visible images of each of the plurality of spatial trackers), it indicates that the two-dimensional mask m_{i,j} corresponding to the spatial tracker P_{i,j} is under-segmented, and the two-dimensional mask m_{i,j} corresponding to the spatial tracker P_{i,j} is discarded. The consistency rate of the discarded two-dimensional mask is not calculated. In this way, in some embodiments of the present disclosure, the clustering of the two-dimensional masks of the intersecting first images is achieved by tracking the rasterization participated in by the Gaussian points, and the noise segmentation is filtered. In some embodiments of the present disclosure, the Gaussian points back-projected by the two-dimensional masks clustered under one instance belong to (or correspond to) the instance, the Gaussian points belonging to the same instance are merged, and isolated points may be filtered out by using DBSCAN (Density-Based Spatial Clustering of Applications with Noise). The merged Gaussian point set is used as the three-dimensional mask of the instance, but not every Gaussian point is merged, and some Gaussian points are not merged due to isolation or under-segmented two-dimensional masks.

In some embodiments of the present disclosure, the feature field is pre-trained by: acquiring a two-dimensional mask corresponding to an instance in a training image and a three-dimensional Gaussian point cloud corresponding to the training image, where the training image is an image of a second scene from a different viewpoint, the two-dimensional mask corresponding to the instance in the training image has been clustered, and a Gaussian point in the three-dimensional Gaussian point cloud corresponding to the training image is assigned a random feature; and performing iterative training on the feature field, the iterative training including: calculating a total loss function according to the feature of the Gaussian point, the two-dimensional mask of the training image, and a clustering result of the two-dimensional mask corresponding to the instance in the training image; adjusting a parameter of the feature field; and re-assigning the feature to the Gaussian point in the three-dimensional Gaussian point cloud corresponding to the training image using the feature field; where the total loss function includes: a single-image loss function, a multi-image loss function, and a three-dimensional loss function.

In some embodiments, three types of masks are actually obtained through the clustering of the two-dimensional masks, including: a two-dimensional mask from a single first image, a two-dimensional mask clustered from a plurality of first images (the two-dimensional masks belonging to the same instance in each of the first images are assigned the same label, and the two-dimensional masks belonging to different instances have different labels, that is, the “2D cross-view mask (2D cross-view CL)” in FIG. 3), and a three-dimensional mask (that is, after the spatial trackers of the two-dimensional masks corresponding to the same instance are merged, DBSCAN filtering is performed to obtain a Gaussian point set corresponding to each instance, the Gaussian point set corresponding to one instance is assigned the same label, and the Gaussian point sets corresponding to different instances correspond to different labels, that is, the “3D global object mask” in FIG. 3). In order to merge the unmerged Gaussian points according to the corresponding instance, a feature field needs to be used. The feature field is used to assign a feature to a Gaussian point. After the feature is assigned to the Gaussian point, an average value of the features of each Gaussian point set of the instance is calculated, and then the cosine similarity between the feature of the unmerged Gaussian point and each average value is calculated. If the cosine similarity between the feature of the unclassified Gaussian point and the average value of the features of a certain Gaussian point set reaches a threshold value, such as 0.9, it is considered that the unclassified Gaussian point and this Gaussian point set belong to (or correspond to) the same instance and need to be merged. In order to merge the unclassified Gaussian points, the feature field needs to be trained first, so that the feature field may assign a feature to each Gaussian point, and the features of the Gaussian points corresponding to the same instance need to be similar, while the features of the Gaussian points corresponding to different instances are not similar. The training of the feature field is a process of spatial contrastive learning. Specifically, a training image is used, and the training image is an image for training, which is processed in advance in a similar manner to the first image, that is, the operations of steps S12 to S14 are performed to obtain three types of masks of the training image. The Gaussian points in the three-dimensional Gaussian point cloud corresponding to the training image are assigned random features. A loss function needs to be used in the process of training the feature field, and the training process is a repeated iterative training process. In each iterative training, the following steps are performed: calculating a total loss function, adjusting a parameter of the feature field, and re-assigning the feature to the Gaussian point using the feature field with the adjusted parameter. The total loss function is minimized through a plurality of iterations. Through repeated iterative training, the feature field may assign features to the Gaussian points that may distinguish the instances corresponding to each other.

In some embodiments of the present disclosure, the total loss function is calculated by: randomly selecting one training image as a target image; performing rasterization rendering of the three-dimensional Gaussian point cloud of the training image according to a camera pose of the target image to obtain a first semantic feature map of the target image; randomly collecting a first number of first pixels from the target image; obtaining a single-image loss function using contrastive learning based on the two-dimensional mask corresponding to the first pixel and a semantic feature corresponding to the first pixel in the first semantic feature map; acquiring a plurality of adjacent images, and performing rasterization rendering of the three-dimensional Gaussian point cloud of the training image according to camera poses of the adjacent images to obtain a second semantic feature map of the adjacent images, where the adjacent images are training images different from the target image; selecting a second number of second pixels from the plurality of adjacent images, where the second number of pixels correspond to the same instance; obtaining a multi-image loss function using the contrastive learning based on the semantic feature corresponding to the second pixel in the second semantic feature map; randomly selecting a third number of Gaussian points from the Gaussian points visible in the target image; obtaining a three-dimensional loss function using the contrastive learning according to features of the third number of Gaussian points and the corresponding instance; and calculating a weighted sum of the single-image loss function, the multi-image loss function, and the three-dimensional loss function as the total loss function.

In some embodiments, before the iterative training of the feature field, the feature of the Gaussian point is randomly initialized first, and then the feature field is trained. In each iterative training, three loss functions are calculated separately, and the three-dimensional Gaussian point cloud (or Gaussian points) used in calculating the three loss functions is the three-dimensional Gaussian point cloud (or Gaussian points) corresponding to the training image.

In some embodiments, when calculating the single-image loss function, the “2D same-view contrastive learning (2D same-view CL)” in step 2 in FIG. 3 is adopted. A training image is randomly selected as the target image, and the rasterization rendering of the three-dimensional Gaussian point cloud is performed using the camera pose of the target image to obtain a two-dimensional first semantic feature map having the camera pose of the target image. The semantic feature map includes a semantic feature, which is a value of the feature of the Gaussian point rendered onto the first semantic feature map. That is, for any pixel on the first semantic feature map, the value of the feature of the Gaussian point that generates the pixel rendered onto the two-dimensional image (the first semantic feature map) is the semantic feature corresponding to the pixel. At the same time, the two-dimensional mask of the target image is known in advance, and a first number (for example, 1024) of pixels are randomly collected on the first semantic feature map. For the semantic features corresponding to these pixels, contrastive learning is performed according to the corresponding two-dimensional mask to obtain the single-image loss function. For example, the single-image loss function may include: the difference between the semantic features of the pixels corresponding to the same two-dimensional mask (instance), and the difference between the semantic features of the pixels corresponding to different two-dimensional masks (instances) may also be subtracted.

In some embodiments, when calculating the multi-image loss function, the “2D cross-view contrastive learning” in step 2 in FIG. 3 is adopted, which utilizes the consistency of the two-dimensional masks corresponding to the same instance in the plurality of images. A plurality of adjacent images (for example, 3, 4 or 5) of the target image are selected, and similar to that described above, the three-dimensional Gaussian point cloud is rasterized according to the camera pose of each of the adjacent images to obtain the semantic feature map, that is, the second semantic feature map, of each of the adjacent images. A second number (for example, 1024) of pixels are selected from the second semantic feature map, and these pixels correspond to the two-dimensional mask of the same instance. The semantic feature corresponding to each pixel is determined, and then the multi-image loss function is obtained using the contrastive learning. The multi-image loss function may include the difference between the semantic features of the pixels corresponding to the same instance.

In some embodiments, when calculating the three-dimensional loss function, the “3D global contrastive learning (3D Global CL)” in step 2 in FIG. 3 is adopted. Part of the Gaussian points in the three-dimensional Gaussian point cloud have been merged according to the instance (although the proportion is not too high, about 40,000 Gaussian points are merged out of 100,000 Gaussian points). Therefore, these merged Gaussian points may be used for contrastive learning to directly optimize the three-dimensional parameters, and at the same time, they have a guiding effect on the two-dimensional contrastive learning. For the Gaussian points visible in the target view (that is, the Gaussian points covered by the back-projection of the two-dimensional mask seen by the target view), a third number (for example, 1024) of Gaussian points are randomly selected from them, and the three-dimensional loss function is obtained using the contrastive learning according to the corresponding instance. The three-dimensional loss function may include: the difference between the features of the Gaussian points corresponding to the same instance, and the difference between the features of the Gaussian points corresponding to different instances may also be subtracted.

In some embodiments of the present disclosure, a scheme of spatial contrastive learning is designed, which utilizes the two-dimensional mask segmentation of the two-dimensional image, the two-dimensional mask segmentation across images, and the instance segmentation pixel of the three-dimensional Gaussian point to guide the training of the feature field. The instance segmentation of the three-dimensional Gaussian point is highly robust at the global level and may guide the learning of the two-dimensional semantic feature. At the same time, the two-dimensional mask segmentation supplements the feature learning of the Gaussian points filtered as isolated points in the three-dimensional Gaussian points, and mutually guides to learn discriminative features together. After the training is completed, the instance segmentation is performed by calculating the cosine similarity between the mean value of the features of the Gaussian point set merged according to the instance and the feature of each Gaussian point. If the cosine similarity reaches 0.9, it is considered that the Gaussian points correspond to the same instance.

In some embodiments of the present disclosure, the generating a three-dimensional model of the instance according to the segmented three-dimensional Gaussian point cloud includes: generating latent space representations of the instance in a plurality of preset viewpoints according to a three-dimensional Gaussian point cloud part corresponding to the instance; selecting latent space representations of at least two viewpoints from the latent space representations of the plurality of preset viewpoints as conditional images, and using the remaining ones as second images; acquiring an existing region in the second image in which the instance is displayed as an initial region; adding initial noise to the second image, where the intensity of the initial noise added to the existing region in which the instance is displayed in the second images is lower than the intensity of the initial noise added to an unknown region in which the instance is not displayed in the second images; performing denoising iterations on the second image s by alternately using the respective conditional images as an input condition to predict a missing part of the instance in the first image; and generating the three-dimensional model of the instance by using the conditional images and the second images after denoising iterations.

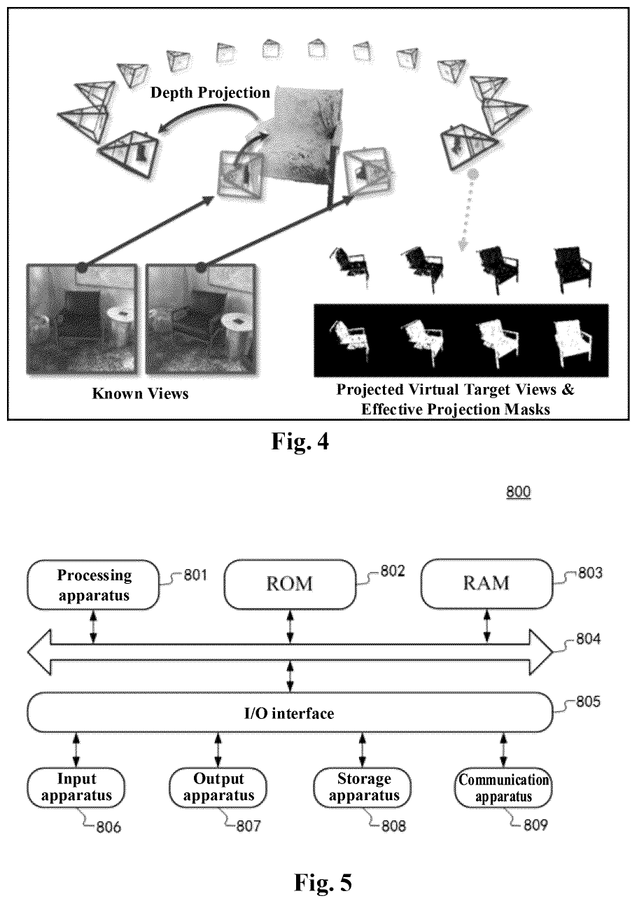

In some embodiments, a multi-condition guided three-dimensional model generation scheme is adopted in this embodiment. After the Gaussian points are segmented according to the instance to which they belong (also referred to as correspond), a three-dimensional model of any of the instances may be generated. An instance may be selected by the user first, and then the three-dimensional model of the instance is generated. The Gaussian points of the instance shown in the three-dimensional Gaussian point cloud of the first image are incomplete (as shown in the content below the “incomplete reconstruction” in FIG. 2 and the “incomplete segmented objects” in FIG. 3), because it may be impossible to completely photograph all parts of the instance in the first image. For example, if the instance is a table and the fourth leg of the table is not photographed in each of the first images, there is no part corresponding to the fourth leg in the three-dimensional Gaussian point cloud. In the process of generating the three-dimensional model, in this embodiment, both the occluded part and the observable part of the reconstructed three-dimensional model should be kept complete, and it is also expected to have a realistic appearance and shape. For this purpose, in this embodiment, an in-situ generation scheme is adopted, so that the generated three-dimensional model may be aligned with the geometry, appearance and spatial position of the instance in the original first image, and is adjusted by using the known information. Specifically, in some embodiments, as shown in FIG. 3, for any instance, the part corresponding to the instance in the three-dimensional Gaussian point cloud (the “incomplete segmented objects” in FIG. 3) is acquired, and the latent space representations (latent codes) in a plurality of preset viewpoints are generated using this part. As shown in FIG. 3, the images of 16 viewpoints on the peripheral side of the “geometry-based known feature projection” are the latent space representations of the preset viewpoints (reference may be made to the projection images of 16 viewpoints shown around the chair in FIG. 4). The latent space representations of at least two viewpoints are selected therefrom as the conditional images (such as the two chair images in the “alternating conditional views” in FIG. 3), and the rest are used as the second images. The existing region of the instance (the chair in FIG. 3) in each of the current second images is acquired as the initial region. Then, the initial noise is added to the second image, where pure noise may be added to the region where the instance is shown, and the noise added to the existing region where the instance is shown is relatively weak. In this way, the noisy second image (that is, the “noisy target view” in FIG. 3) is obtained, which is transmitted to the 3D generation network for denoising iteration. The purpose of the denoising iteration is to predict the unknown missing part of the instance according to the existing part of the instance, and the conditional images are used as a guide for the denoising process to help predict the missing part. It is considered that during the generation process, the best viewpoint for each instance in a cluttered scene is not directly available. Therefore, as shown in FIG. 4, in this embodiment, 16 viewpoints (the known views in FIG. 4 are the first images, and the viewpoints corresponding to them happen to be the same as two of the 16 viewpoints) around the segmented instance may be selected. These viewpoints start from 30 degrees and are linearly distributed in the range of 360 degrees. The viewpoint with the least occlusion from the object is selected as the viewpoint corresponding to an ideal conditional image, and those viewpoints with occlusions are regarded as non-visible viewpoints and need to be guided and supplemented by the known part. After obtaining the denoised second image, the instance is optimized in combination with the selected conditional images. The original first image ensures the consistency of the existing part of the instance, and the generated missing part is responsible for supplementing the invisible part, and finally, the complete instance reconstruction guided by the known part is realized (see the “padding” part in FIG. 2 and the “complete object” part in FIG. 3).

In some embodiments of the present disclosure, the performing denoising iterations on the second images by alternately using the respective conditional images as the input condition includes performing the following steps in each denoising iteration: if the denoising iteration is not the first denoising iteration, replacing the existing region on the second image with the initial region added with the first noise, where the intensity of the first noise used in the current denoising iteration is lower than the intensity of the initial noise and higher than the intensity of the first noise used in the next denoising iteration; predicting the noise added to the second images by using the respective conditional images as an input condition to obtain a plurality of second noises; calculating an average value of the plurality of second noises as a third noise; and subtracting the third noise from the second image to obtain the second image after the current denoising iteration.

In some embodiments, in the first iteration, each of the conditional images is used as the input condition, which is used to ensure the known part of the instance and guide the denoising of the missing part. Assuming that there are N conditional images, when predicting M second images, the N conditions are used as input conditions to predict the noise added to the M second images, and thus N×M second noises are obtained. Then, the average value of the N×M second noises is calculated as the third noise, and the third noise is subtracted from the second image. The second image after denoising iteration is used as the input of the next denoising iteration. It should be noted that because the prediction of the existing region is actually not needed, and in order to guide the unknown region, the noise added to the existing region is relatively weak. Therefore, in the process of denoising iteration after the first denoising iteration, the initial region saved initially is added with the first noise and then used to replace the existing region in the second image input in the denoising iteration. Moreover, because the second noise predicted in each denoising iteration will be gradually weakened, the first noise is time-dependent noise (TD Noise) (see FIG. 3), and the intensity of the first noise is gradually weakened with the progress of the denoising iteration.

In some embodiments of the present disclosure, a manner of alternately using conditional images to guide denoising is designed, in which the conditional images re-generated through Gaussian splatting are gradually input as alternating conditions in the denoising process, and the noise prediction of the second image is averaged in each denoising iteration process. In some embodiments of the present disclosure, by utilizing the existing geometric prior knowledge of the instance, a geometry-aware projection strategy is designed to further enhance the consistency of predicting the missing part from the known part. Specifically, in the diffusion process of denoising iteration, time-dependent noise is added to the initial region and projected onto the visible pixels of the second image based on the rendering depth, thereby forcing the prediction results to be consistent in the prediction results of the known part, while the missing part is initialized as random noise and predicted through the diffusion process.

In some embodiments of the present disclosure, the two-dimensional mask clustering guided by the spatial Gaussian tracker is adopted, and by considering the spatial relationship of the spatial Gaussian tracker corresponding to the two-dimensional mask, the clustering of the two-dimensional masks of the intersecting first images and the filtering of the noise masks are realized. In some embodiments, the contrastive learning in the two-dimensional image, the cross two-dimensional image contrastive learning, and the three-dimensional Gaussian global contrastive learning are utilized, and the feature field of Gaussian with significant features is learned through mutual guidance of the two-dimensional and three-dimensional mask priors, and fine-grained and open-ended object decoupling of the scene is realized. In some embodiments, the multi-condition guided three-dimensional generation is used, and the three-dimensional generation model is guided to fill in the missing part by effectively utilizing the known information of the scene, thereby ensuring the alignment with the original scene in terms of geometry and appearance. In some embodiments, the best viewpoint for guiding the generation model is selected as the conditional image through the occlusion relationship between the scene and the selected viewpoint. Meanwhile, in order to ensure the rationality of the generation result and the alignment between the visible known part and the original scene, the original observation and the generation viewpoint are used for joint optimization and reconstruction.

In some embodiments of the present disclosure, on the basis of the original real-time rendering representation Gaussian splatting of the scene, high-precision interactive object three-dimensional segmentation may be realized, and the object (instance) to be segmented may be selected by clicking the mouse. At the same time, for the segmented object, the unobserved missing part may be reasonably repaired, and the final object model supports direct copying and moving in the scene, as well as exporting the final model.

In some embodiments of the present disclosure, an image processing apparatus is further provided, including:
an acquiring unit, configured to acquire a plurality of first images, where the plurality of first images are images of a first scene from different viewpoints, the first scene corresponds to a three-dimensional Gaussian point cloud generated according to the first images, and the three-dimensional Gaussian point cloud includes a plurality of Gaussian points;
a control unit, configured to perform two-dimensional instance segmentation on an instance of the first scene in the first image to obtain a plurality of two-dimensional masks;
where the control unit is configured to back-project the two-dimensional masks onto the three-dimensional Gaussian point cloud;
the control unit is configured to cluster the respective two-dimensional masks according to a spatial relationship of the three-dimensional Gaussian point cloud, where the respective two-dimensional masks corresponding to a same instance are clustered together;
the control unit is configured to assign a feature to the respective Gaussian points using a pre-trained feature field;
the control unit is configured to segment the Gaussian points by the instance to which the Gaussian points belong according to a clustering result of the two-dimensional masks and the feature of the respective Gaussian points;
the control unit is configured to generate a three-dimensional model of the instance according to the segmented three-dimensional Gaussian point cloud; and
where the three-dimensional model includes a missing part of the instance that is not displayed in the first image.

For the embodiments of the apparatuses, since they basically correspond to the method embodiments, reference may be made to the partial description of the method embodiments for the relevant parts. The apparatus embodiments described above are only illustrative, and the modules described as separate modules may or may not be separated. Some or all of the modules may be selected according to actual needs to achieve the purpose of the solutions of the embodiments. Those of ordinary skill in the art may understand and implement without creative efforts.

The method and apparatus of the present disclosure are described above based on the embodiments and application examples. Furthermore, the present disclosure also provides an electronic device and a computer-readable storage medium, which will be described below.

Reference is made to FIG. 5 below, which shows a schematic structural diagram of an electronic device (such as a terminal device or a server) 800 suitable for implementing the embodiments of the present disclosure. The terminal device in the embodiments of the present disclosure may include, but is not limited to, mobile terminals such as a mobile phone, a notebook computer, a digital broadcast receiver, a PDA (personal digital assistant), a PAD (tablet computer), a PMP (portable multimedia player), a vehicle-mounted terminal (such as a vehicle navigation terminal), etc., and fixed terminals such as a digital TV, a desktop computer, etc. The electronic device shown in the figure is only an example, and should not impose any limitation on the functions and scope of use of the embodiments of the present disclosure.

The electronic device 800 may include a processing apparatus (such as a central processing unit, a graphics processing unit, etc.) 801, which may perform various appropriate actions and processing according to a program stored in a read-only memory (ROM) 802 or a program loaded from a storage apparatus 808 into a random access memory (RAM) 803. The RAM 803 further stores various programs and data required for operations of the electronic device 800. The processing apparatus 801, the ROM 802 and the RAM 803 are connected to each other through a bus 804. An input/output (I/O) interface 805 is also connected to the bus 804.

Usually, the following apparatuses may be connected to the I/O interface 805: an input apparatus 806 including, for example, a touch screen, a touchpad, a keyboard, a mouse, a camera, a microphone, an accelerometer, a gyroscope, etc. ; an output apparatus 807 including, for example, a liquid crystal display (LCD), a speaker, a vibrator, etc. ; the storage apparatus 808 including, for example, a magnetic tape, a hard disk, etc. ; and a communication apparatus 809. The communication apparatus 809 may allow the electronic device 800 to perform wireless or wired communication with other devices to exchange data. Although the electronic device 800 having various apparatuses is shown in the figure, it should be understood that not all the apparatuses shown here need to be implemented or provided. More or fewer apparatuses may be implemented or provided alternatively.

In particular, according to the embodiments of the present disclosure, the process described above with reference to the flowchart may be implemented as a computer software program. For example, the embodiments of the present disclosure include a computer program product, which includes a computer program carried on a computer-readable medium, and the computer program contains program code for performing the method shown in the flowchart. In such an embodiment, the computer program may be downloaded and installed from a network through the communication apparatus 809, or installed from the storage apparatus 808, or installed from the ROM 802. When the computer program is executed by the processing apparatus 801, the above-mentioned functions defined in the method of the embodiments of the present disclosure are executed.

It should be noted that the above-mentioned computer-readable medium in the present disclosure may be a computer-readable signal medium, a computer-readable storage medium, or any combination thereof. The computer-readable storage medium may be, for example, but not limited to, an electrical, magnetic, optical, electromagnetic, infrared, or semi-conductive system, apparatus or device, or any combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier wave, and computer-readable program code is carried therein. The data signal propagated in this way may adopt a variety of forms, including but not limited to an electromagnetic signal, an optical signal, or any suitable combination of the above. The computer-readable signal medium may also be any computer-readable medium other than the computer-readable storage medium, and the computer-readable signal medium may send, propagate, or transmit t he program used by or in combination with the instruction execution system, apparatus, or device. The program code contained on the computer-readable medium may be transmitted by any suitable medium, including but not limited to: a wire, an optical cable, a radio frequency (RF), etc., or any suitable combination of the above.

In some implementations, clients and servers may communicate using any currently known or future developed network protocol, such as the Hyper Text Transfer Protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The above computer-readable medium may be contained in the above electronic device, or may exist alone without being assembled into the electronic device.

The above computer-readable medium carries one or more programs, and when the one or more programs are executed by the electronic device, the electronic device is caused to perform the above method of the present disclosure.

The computer program code for performing the operations of the present disclosure may be written in one or more programming languages or a combination thereof, where the programming languages include object-oriented programming languages such as Java, Smalltalk, and C++, and may also include conventional procedural programming languages such as “C” language or similar programming languages. The program code may be executed entirely on a user computer, partly on a user computer, as a stand-alone software package, partly on a user computer and partly on a remote computer, or entirely on a remote computer or a server. In the case of involving a remote computer, the remote computer may be connected to the user computer through any kind of network, including a local area network (LAN) or a wide area network (WAN), or it may be connected to an external computer (for example, connected by using Internet provided by an Internet service provider).

The flowcharts and block diagrams in the drawings illustrate the possibly implemented architectures, functions and operations of the system, method and computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented by means of software, and may also be implemented by means of hardware. The name of a unit does not constitute a limitation on the unit itself under certain circumstances.

The functions described above herein may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), etc.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semi-conductive system, apparatus or device, or any suitable combination of the above. More specific examples of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, provided is an image processing method, including:
acquiring a plurality of first images, where the plurality of first images are images of a first scene from different viewpoints, the first scene corresponds to a three-dimensional Gaussian point cloud generated according to the first images, and the three-dimensional Gaussian point cloud includes a plurality of Gaussian points;
performing two-dimensional instance segmentation on an instance in the first image to obtain a plurality of two-dimensional masks;
back-projecting the two-dimensional masks onto the three-dimensional Gaussian point cloud;
clustering the respective two-dimensional masks according to a spatial relationship of the three-dimensional Gaussian point cloud, where the respective two-dimensional masks corresponding to a same instance are clustered together;
assigning a feature to the respective Gaussian points using a pre-trained feature field;
segmenting the Gaussian points by the instance to which the Gaussian points belong according to a clustering result of the two-dimensional masks and the feature of the respective Gaussian points; and
generating a three-dimensional model of the instance according to the segmented three-dimensional Gaussian point cloud;
where the three-dimensional model includes a missing part of the instance that is not displayed in the first image.

According to one or more embodiments of the present disclosure, provided is an image processing method, where the clustering respective the two-dimensional masks according to the spatial relationship of the three-dimensional Gaussian point cloud includes:
determining a spatial tracker corresponding to the respective two-dimensional masks of the respective first images; and
determining whether different two-dimensional masks belong to the same instance according to the spatial tracker, to cluster the respective two-dimensional masks;
where the spatial tracker corresponding to the two-dimensional mask of the first image includes: a set of Gaussian points that participate in rasterization of a pixel corresponding to the two-dimensional mask in the first image and have transparency exceeding a first threshold.

According to one or more embodiments of the present disclosure, provided is an image processing method, where determining whether different two-dimensional masks belong to the same instance according to the spatial tracker includes determining whether any two two-dimensional masks belong to the same instance by:
determining a consistency rate between a first spatial tracker and a second spatial tracker; and
determining that the first spatial tracker and the second spatial tracker belong to the same instance in response to the consistency rate being greater than a second threshold;
where the first spatial tracker and the second spatial tracker are spatial trackers respectively corresponding to any two two-dimensional masks;
the consistency rate is equal to a ratio of a number of shared containing images of the first spatial tracker and the second spatial tracker to a number of shared visible images of the first spatial tracker and the second spatial tracker;
if at least a first preset proportion of Gaussian points in a spatial tracker participate in rasterization of a pixel of another first image, and the other first image is different from the first image from which the two-dimensional mask corresponding to the spatial tracker originates, the other first image is a visible image of the spatial tracker;
if at least a second preset proportion of Gaussian points in a spatial tracker appear in another spatial tracker, the first image from which the two-dimensional mask corresponding to the other spatial tracker originates is a containing image of the spatial tracker, and the first image from which the two-dimensional mask corresponding to the other spatial tracker comes is different from the first image from which the two-dimensional mask corresponding to the spatial tracker originates; and
the second threshold is not less than 0.8 and less than 1, the second preset proportion is greater than the first preset proportion, and the second preset proportion is greater than 50%.

According to one or more embodiments of the present disclosure, provided is an image processing method, where if a spatial tracker has same Gaussian points as at least two other spatial trackers, the spatial tracker always participates in rasterization of pixels of visible images of the at least two other spatial trackers, the first image from which the two-dimensional mask corresponding to the spatial tracker comes is different from the first images from which the two-dimensional masks corresponding to the at least two other spatial trackers originate, and the two-dimensional masks corresponding to the at least two other spatial trackers come from a same first image, the two-dimensional mask corresponding to the spatial tracker is discarded.

According to one or more embodiments of the present disclosure, provided is an image processing method, where the feature field is pre-trained by:
acquiring a two-dimensional mask corresponding to an instance in a training image and a three-dimensional Gaussian point cloud corresponding to the training image, where the training image is an image of a second scene from a different viewpoint, the two-dimensional mask corresponding to the instance in the training image has been clustered, and a Gaussian point in the three-dimensional Gaussian point cloud corresponding to the training image is assigned a random feature; and
performing iterative training on the feature field, the iterative training including: calculating a total loss function according to the feature of the Gaussian point, the two-dimensional mask of the training image, and a clustering result of the two-dimensional mask corresponding to the instance in the training image; adjusting a parameter of the feature field; and reassigning the feature to the Gaussian point in the three-dimensional Gaussian point cloud corresponding to the training image using the feature field;
where the total loss function includes: a single-image loss function, a multi-image loss function, and a three-dimensional loss function.

According to one or more embodiments of the present disclosure, provided is an image processing method, where the total loss function is calculated by:
randomly selecting one of the training image as a target image; performing rasterization rendering of the three-dimensional Gaussian point cloud of the training image according to a camera pose of the target image to obtain a first semantic feature map of the target image; randomly collecting a first number of first pixels from the target image; and obtaining a single-image loss function using contrastive learning based on the two-dimensional mask corresponding to the first pixel and a semantic feature corresponding to the first pixel in the first semantic feature map;
acquiring a plurality of adjacent images, and performing rasterization rendering of the three-dimensional Gaussian point cloud of the training image according to camera poses of the adjacent images to obtain a second semantic feature map of the adjacent images, where the adjacent images are training images different from the target image; selecting a second number of second pixels from the plurality of adjacent images, where the second number of pixels correspond to the same instance; obtaining a multi-image loss function using the contrastive learning based on the semantic feature corresponding to the second pixel in the second semantic feature map;
randomly selecting a third number of Gaussian points from the Gaussian points visible in the target image; obtaining a three-dimensional loss function using the contrastive learning according to features of the third number of Gaussian points and the corresponding instance; and
calculating a weighted sum of the single-image loss function, the multi-image loss function, and the three-dimensional loss function as the total loss function.

According to one or more embodiments of the present disclosure, provided is an image processing method, where the generating a three-dimensional model of the instance according to the segmented three-dimensional Gaussian point cloud includes:
generating latent space representations of the instance in a plurality of preset viewpoints according to a three-dimensional Gaussian point cloud part corresponding to the instance;
selecting latent space representations of at least two viewpoints from the latent space representations of the plurality of preset viewpoints as conditional images, and using the rest as second images;
acquiring an existing region in the second image where the instance is shown as an initial region;
adding initial noise to the second image, where the intensity of the initial noise added to the existing region in the second image where the instance is shown is lower than the intensity of the initial noise added to an unknown region in the second image where the instance is not shown;
performing denoising iterations on the second image using each of the conditional images alternately as an input condition to predict a missing part of the instance in the first image; and
generating the three-dimensional model of the instance using the conditional images and the second image after denoising iterations.

According to one or more embodiments of the present disclosure, provided is an image processing method, where the performing denoising iterations on the second image using each of the conditional images alternately as an image condition includes performing the following steps in each denoising iteration:
if the denoising iteration is not the first denoising iteration, replacing the existing region on the second image with the initial region added with the first noise, where the intensity of the first noise used in the denoising iteration is lower than the intensity of the initial noise and higher than the intensity of the first noise used in the next denoising iteration;
predicting the noise added to the second image using each of the conditional images as an input condition to obtain a plurality of second noises;
calculating an average value of the plurality of second noises as a third noise; and
subtracting the third noise from the second image to obtain the second image after the denoising iteration.

According to one or more embodiments of the present disclosure, provided is an image processing apparatus, including:
an acquiring unit, configured to acquire a plurality of first images, where the plurality of first images are images of a first scene from different viewpoints, the first scene corresponds to a three-dimensional Gaussian point cloud generated according to the first images, and the three-dimensional Gaussian point cloud includes a plurality of Gaussian points;
a control unit, configured to perform two-dimensional instance segmentation on an instance in the first image to obtain a plurality of two-dimensional masks;
where the control unit is configured to back-project the two-dimensional masks onto the three-dimensional Gaussian point cloud;
the control unit is configured to cluster the two-dimensional masks according to a spatial relationship of the three-dimensional Gaussian point cloud, where the two-dimensional masks corresponding to a same instance are clustered together;
the control unit is configured to assign a feature to each Gaussian point using a pre-trained feature field;
the control unit is configured to segment the Gaussian points by the instance to which the Gaussian points belong according to a clustering result of the two-dimensional masks and the feature of each Gaussian point;
the control unit is configured to generate a three-dimensional model of the instance according to the segmented three-dimensional Gaussian point cloud; and
where the three-dimensional model includes a missing part of the instance that is not shown in the first image.

According to one or more embodiments of the present disclosure, provided is an electronic device, including: at least one memory and at least one processor;
where the at least one memory is configured to store program code, and the at least one processor is configured to call the program code stored in the at least one memory to perform the method according to any one of the above.

According to one or more embodiments of the present disclosure, provided is a computer-readable storage medium, the computer-readable storage medium is configured to store program code, and the program code, when run by a processor, causes the processor to perform the above method.

The above description is only the preferred embodiments of the present disclosure and an illustration of the technical principles employed. Those skilled in the art should understand that the scope of disclosure involved in the present disclosure is not limited to the technical solutions formed by the specific combination of the above technical features, and should also cover, without departing from the above disclosed concept, other technical solutions formed by any combination of the above technical features or equivalent features thereof. For example, a technical solution formed by replacing the above features with the technical features disclosed in the present disclosure (but not limited to) with similar functions.

Furthermore, although operations are depicted in a particular order, it should not be understood that these operations are required to be performed in a specific order as illustrated or in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments may also be implemented in combination in a single embodiment. Conversely, various features described in the context of a single embodiment may also be implemented in a plurality of embodiments individually or in any suitable sub-combination.

Although the subject matter has been described in language specific to structural features and/or method logical actions, it should be understood that the subject matter defined in the appended claims is not necessarily limited to the specific features or actions described above. Conversely, the specific features and actions described above are merely exemplary forms for implementing the claims.

I/We claim:

1. An image processing method, comprising:
acquiring a plurality of first images, the plurality of first images being images of a first scene from different viewpoints, the first scene corresponding to a three-dimensional Gaussian point cloud generated according to the first images, and the three-dimensional Gaussian point cloud comprising a plurality of Gaussian points;
performing two-dimensional instance segmentation on an instance in the first images to obtain a plurality of two-dimensional masks;
back-projecting the two-dimensional masks onto the three-dimensional Gaussian point cloud;
clustering the respective two-dimensional masks according to a spatial relationship of the three-dimensional Gaussian point cloud, wherein the respective two-dimensional masks corresponding to a same instance are clustered together;
assigning a feature to the respective Gaussian points using a pre-trained feature field;
segmenting the Gaussian points by the instance to which the Gaussian points belong according to a clustering result of the two-dimensional masks and the feature of the respective Gaussian points; and
generating a three-dimensional model of the instance according to the segmented three-dimensional Gaussian point cloud; and
wherein the three-dimensional model comprises a missing part of the instance that is not displayed in the first image.

2. The method of claim 1, wherein clustering the respective two-dimensional masks according to the spatial relationship of the three-dimensional Gaussian point cloud comprises:
determining a spatial tracker corresponding to the respective two-dimensional masks of the respective first images; and
determining whether different two-dimensional masks belong to the same instance according to the spatial tracker, to cluster the respective two-dimensional masks; and
wherein the spatial tracker corresponding to the two-dimensional masks of the first image comprises: a set of Gaussian points that participate in rasterization of a pixel corresponding to the two-dimensional mask in the first image and have transparency exceeding a first threshold.

3. The method of claim 2, wherein determining whether different two-dimensional masks belong to the same instance according to the spatial tracker comprises determining whether any two two-dimensional masks belong to the same instance by:
determining a consistency rate between a first spatial tracker and a second spatial tracker; and
determining that the first spatial tracker and the second spatial tracker belong to the same instance in response to the consistency rate being greater than a second threshold;
wherein the first spatial tracker and the second spatial tracker are spatial trackers respectively corresponding to any two two-dimensional masks;
the consistency rate is equal to a ratio of a number of shared containing images of the first spatial tracker and the second spatial tracker to a number of shared visible images of t the first spatial tracker and the second spatial tracker;
in response to at least a first preset proportion of Gaussian points in a spatial tracker participating in rasterization of a pixel of another first image, and the other first image being different from the first image from which the two-dimensional mask corresponding to the spatial tracker originates, the other first image is a visible image of the spatial tracker;
in response to at least a second preset proportion of Gaussian points in a spatial tracker appearing in another spatial tracker, the first image from which the two-dimensional mask corresponding to the other spatial tracker originates is containing image of the spatial tracker, and the first image from which the two-dimensional mask corresponding to the other spatial tracker originates is different from the first image from which the two-dimensional mask corresponding to the spatial tracker originates; and
the second threshold is not less than 0.8 and less than 1, the second preset proportion is greater than the first preset proportion, and the second preset proportion is greater than 50%.

4. The method of claim 3, wherein
in response to a spatial tracker having same Gaussian points as at least two other spatial trackers, the spatial tracker always participating in rasterization of pixels of visible images of the at least two other spatial trackers, the first image from which the two-dimensional mask corresponding to the spatial tracker originates being different from the first images from which the two-dimensional masks corresponding to the at least two other spatial trackers originate, and the two-dimensional masks corresponding to the at least two other spatial trackers originating from a same first image, the two-dimensional mask corresponding to the spatial tracker is discarded.

5. The method of claim 1, wherein the feature field is pre-trained by:
acquiring a two-dimensional mask corresponding to an instance in training images and a three-dimensional Gaussian point cloud corresponding to the training images, wherein the training images are images of a second scene from different viewpoints, the two-dimensional mask corresponding to the instance in the training images has been clustered, and a Gaussian point in the three-dimensional Gaussian point cloud corresponding to the training images is assigned a random feature; and
performing iterative training on the feature field, the iterative training comprising: calculating a total loss function according to the feature of the Gaussian point, two-dimensional masks of the training images, and a clustering result of the two-dimensional mask corresponding to the instance in the training images; adjusting a parameter of the feature field; and reassigning a feature to the Gaussian point in the three-dimensional Gaussian point cloud corresponding to the training images using the feature field;
wherein the total loss function comprises: a single-image loss function, a multi-image loss function, and a three-dimensional loss function.

6. The method of claim 5, wherein the total loss function is calculated by:
randomly selecting one of the training images as a target image; performing rasterization rendering of the three-dimensional Gaussian point cloud of the training images according to a camera pose of the target image to obtain a first semantic feature map of the target image; randomly collecting a first number of first pixels from the target image; and obtaining the single-image loss function using contrastive learning based on the two-dimensional mask corresponding to the first pixels and a semantic feature corresponding to the first pixels in the first semantic feature map;
acquiring a plurality of adjacent images, and performing rasterization rendering of the three-dimensional Gaussian point cloud of the training images according to camera poses of the adjacent images to obtain a second semantic feature map of the adjacent images, wherein the adjacent images are training images different from the target image; selecting a second number of second pixels from the plurality of adjacent images, wherein the second number of pixels correspond to the same instance; obtaining the multi-image loss function using the contrastive learning based on the semantic feature corresponding to the second pixels in the second semantic feature map;
randomly selecting a third number of Gaussian points from the Gaussian points visible in the target image; obtaining the three-dimensional loss function using the contrastive learning according to features of the third number of Gaussian points and the corresponding instance; and
calculating a weighted sum of the single-image loss function, the multi-image loss function, and the three-dimensional loss function as the total loss function.

7. The method of claim 1, wherein generating the three-dimensional model of the instance according to the segmented three-dimensional Gaussian point cloud comprises:
generating latent space representations of the instance in a plurality of preset viewpoints according to a part of the three-dimensional Gaussian point cloud corresponding to the instance;
selecting latent space representations of at least two viewpoints from the latent space representations of the plurality of preset viewpoints as conditional images, and using remaining ones as second images;
acquiring an existing region in the second images in which the instance is displayed as an initial region;
adding an initial noise to the second images, wherein an intensity of the initial noise added to the existing region in which the instance is displayed in the second images is lower than an intensity of the initial noise added to an unknown region in which the instance is not displayed in the second images;
performing denoising iterations on the second images by alternately using the respective conditional images as an input condition to predict the missing part of the instance in the first image; and
generating the three-dimensional model of the instance by using the conditional images and the second images after the denoising iterations.

8. The method of claim 7, wherein performing the denoising iterations on the second images by alternately using the respective conditional images as the input condition comprises performing the following steps in each of the denoising iterations:
in response to the denoising iteration being not the first denoising iteration, replacing the existing region on the second images with the initial region added with first noise, wherein an intensity of the first noise used in a current denoising iteration is lower than an intensity of the initial noise and higher than an intensity of the first noise used in a next denoising iteration;
predicting a noise added to the second images by using the respective conditional images as the input condition to obtain a plurality of second noises;
calculating an average value of the plurality of second noises as a third noise; and
subtracting the third noise from the second images to obtain the second images after the current denoising iteration.

9. An electronic device, comprising:
at least one memory and at least one processor;
wherein the at least one memory is configured to store program code, and the program code, when executed by the at least one processor, causes the electronic device to:
acquire a plurality of first images, the plurality of first images being images of a first scene from different viewpoints, the first scene corresponding to a three-dimensional Gaussian point cloud generated according to the first images, and the three-dimensional Gaussian point cloud comprising a plurality of Gaussian points;
perform two-dimensional instance segmentation on an instance in the first images to obtain a plurality of two-dimensional masks;
back-project the two-dimensional masks onto the three-dimensional Gaussian point cloud;
cluster the respective two-dimensional masks according to a spatial relationship of the three-dimensional Gaussian point cloud, wherein the respective two-dimensional masks corresponding to a same instance are clustered together;
assign a feature to the respective Gaussian points using a pre-trained feature field;
segment the Gaussian points by the instance to which the Gaussian points belong according to a clustering result of the two-dimensional masks and the feature of the respective Gaussian points; and
generate a three-dimensional model of the instance according to the segmented three-dimensional Gaussian point cloud; and
wherein the three-dimensional model comprises a missing part of the instance that is not displayed in the first image.

10. The electronic device of claim 9, wherein the program code causing the electronic device to cluster the respective two-dimensional masks according to the spatial relationship of the three-dimensional Gaussian point cloud further causes the electronic device to:
determine a spatial tracker corresponding to the respective two-dimensional masks of the respective first images; and
determine whether different two-dimensional masks belong to the same instance according to the spatial tracker, to cluster the respective two-dimensional masks; and
wherein the spatial tracker corresponding to the two-dimensional masks of the first image comprises: a set of Gaussian points that participate in rasterization of a pixel corresponding to the two-dimensional mask in the first image and have transparency exceeding a first threshold.

11. The electronic device of claim 10, wherein to determine whether any two two-dimensional masks belong to the same instance, the program code further causes the electronic device to:
determine a consistency rate between a first spatial tracker and a second spatial tracker; and
determine that the first spatial tracker and the second spatial tracker belong to the same instance in response to the consistency rate being greater than a second threshold;
wherein the first spatial tracker and the second spatial tracker are spatial trackers respectively corresponding to any two two-dimensional masks;
the consistency rate is equal to a ratio of a number of shared containing images of the first spatial tracker and the second spatial tracker to a number of shared visible images of t the first spatial tracker and the second spatial tracker;
in response to at least a first preset proportion of Gaussian points in a spatial tracker participating in rasterization of a pixel of another first image, and the other first image being different from the first image from which the two-dimensional mask corresponding to the spatial tracker originates, the other first image is a visible image of the spatial tracker;
in response to at least a second preset proportion of Gaussian points in a spatial tracker appearing in another spatial tracker, the first image from which the two-dimensional mask corresponding to the other spatial tracker originates is containing image of the spatial tracker, and the first image from which the two-dimensional mask corresponding to the other spatial tracker originates is different from the first image from which the two-dimensional mask corresponding to the spatial tracker originates; and
the second threshold is not less than 0.8 and less than 1, the second preset proportion is greater than the first preset proportion, and the second preset proportion is greater than 50%.

12. The electronic device of claim 11, wherein
in response to a spatial tracker having same Gaussian points as at least two other spatial trackers, the spatial tracker always participating in rasterization of pixels of visible images of the at least two other spatial trackers, the first image from which the two-dimensional mask corresponding to the spatial tracker originates being different from the first images from which the two-dimensional masks corresponding to the at least two other spatial trackers originate, and the two-dimensional masks corresponding to the at least two other spatial trackers originating from a same first image, the two-dimensional mask corresponding to the spatial tracker is discarded.

13. The electronic device of claim 9, wherein to pre-train the feature field, the program code further causes the electronic device to:
acquire a two-dimensional mask corresponding to an instance in training images and a three-dimensional Gaussian point cloud corresponding to the training images, wherein the training images are images of a second scene from different viewpoints, the two-dimensional mask corresponding to the instance in the training images has been clustered, and a Gaussian point in the three-dimensional Gaussian point cloud corresponding to the training images is assigned a random feature; and
perform iterative training on the feature field, the iterative training comprising: calculating a total loss function according to the feature of the Gaussian point, two-dimensional masks of the training images, and a clustering result of the two-dimensional mask corresponding to the instance in the training images; adjusting a parameter of the feature field; and reassigning a feature to the Gaussian point in the three-dimensional Gaussian point cloud corresponding to the training images using the feature field;
wherein the total loss function comprises: a single-image loss function, a multi-image loss function, and a three-dimensional loss function.

14. The electronic device of claim 13, wherein to calculated the total loss function, the program code further causes the electronic device to:
randomly select one of the training images as a target image; perform rasterization rendering of the three-dimensional Gaussian point cloud of the training images according to a camera pose of the target image to obtain a first semantic feature map of the target image; randomly collect a first number of first pixels from the target image; and obtain the single-image loss function using contrastive learning based on the two-dimensional mask corresponding to the first pixels and a semantic feature corresponding to the first pixels in the first semantic feature map;
acquire a plurality of adjacent images, and perform rasterization rendering of the three-dimensional Gaussian point cloud of the training images according to camera poses of the adjacent images to obtain a second semantic feature map of the adjacent images, wherein the adjacent images are training images different from the target image; select a second number of second pixels from the plurality of adjacent images, wherein the second number of pixels correspond to the same instance; obtain the multi-image loss function using the contrastive learning based on the semantic feature corresponding to the second pixels in the second semantic feature map;
randomly select a third number of Gaussian points from the Gaussian points visible in the target image; obtain the three-dimensional loss function using the contrastive learning according to features of the third number of Gaussian points and the corresponding instance; and
calculate a weighted sum of the single-image loss function, the multi-image loss function, and the three-dimensional loss function as the total loss function.

15. The electronic device of claim 9, wherein the program code causing the electronic device to generate the three-dimensional model of the instance according to the segmented three-dimensional Gaussian point cloud further causes the electronic device to:
generate latent space representations of the instance in a plurality of preset viewpoints according to a part of the three-dimensional Gaussian point cloud corresponding to the instance;
select latent space representations of at least two viewpoints from the latent space representations of the plurality of preset viewpoints as conditional images, and use remaining ones as second images;
acquire an existing region in the second images in which the instance is displayed as an initial region;
add an initial noise to the second images, wherein an intensity of the initial noise added to the existing region in which the instance is displayed in the second images is lower than an intensity of the initial noise added to an unknown region in which the instance is not displayed in the second images;
perform denoising iterations on the second images by alternately using the respective conditional images as an input condition to predict the missing part of the instance in the first image; and
generate the three-dimensional model of the instance by using the conditional images and the second images after the denoising iterations.

16. The electronic device of claim 15, wherein the program code causing the electronic device to perform the denoising iterations on the second images by alternately using the respective conditional images as the input condition further causes the electronic device, in each of the denoising iterations, to:
in response to the denoising iteration being not the first denoising iteration, replace the existing region on the second images with the initial region added with first noise, wherein an intensity of the first noise used in a current denoising iteration is lower than an intensity of the initial noise and higher than an intensity of the first noise used in a next denoising iteration;
predict a noise added to the second images by using the respective conditional images as the input condition to obtain a plurality of second noises;
calculate an average value of the plurality of second noises as a third noise; and
subtract the third noise from the second images to obtain the second images after the current denoising iteration.

17. A non-transitory computer-readable storage medium, the computer-readable storage medium is configured to store program code, and the program code, when executed by a processor, causes the processor to:
acquire a plurality of first images, the plurality of first images being images of a first scene from different viewpoints, the first scene corresponding to a three-dimensional Gaussian point cloud generated according to the first images, and the three-dimensional Gaussian point cloud comprising a plurality of Gaussian points;
perform two-dimensional instance segmentation on an instance in the first images to obtain a plurality of two-dimensional masks;
back-project the two-dimensional masks onto the three-dimensional Gaussian point cloud;
cluster the respective two-dimensional masks according to a spatial relationship of the three-dimensional Gaussian point cloud, wherein the respective two-dimensional masks corresponding to a same instance are clustered together;
assign a feature to the respective Gaussian points using a pre-trained feature field;
segment the Gaussian points by the instance to which the Gaussian points belong according to a clustering result of the two-dimensional masks and the feature of the respective Gaussian points; and
generate a three-dimensional model of the instance according to the segmented three-dimensional Gaussian point cloud; and
wherein the three-dimensional model comprises a missing part of the instance that is not displayed in the first image.

18. The non-transitory computer-readable storage medium of claim 17, wherein the program code causing the processor to cluster the respective two-dimensional masks according to the spatial relationship of the three-dimensional Gaussian point cloud further causes the processor to:
determine a spatial tracker corresponding to the respective two-dimensional masks of the respective first images; and
determine whether different two-dimensional masks belong to the same instance according to the spatial tracker, to cluster the respective two-dimensional masks; and
wherein the spatial tracker corresponding to the two-dimensional masks of the first image comprises: a set of Gaussian points that participate in rasterization of a pixel corresponding to the two-dimensional mask in the first image and have transparency exceeding a first threshold.

19. The non-transitory computer-readable storage medium of claim 18, wherein to determine whether any two two-dimensional masks belong to the same instance, the program code further causes the processor to:
determine a consistency rate between a first spatial tracker and a second spatial tracker; and
determine that the first spatial tracker and the second spatial tracker belong to the same instance in response to the consistency rate being greater than a second threshold;
wherein the first spatial tracker and the second spatial tracker are spatial trackers respectively corresponding to any two two-dimensional masks;
the consistency rate is equal to a ratio of a number of shared containing images of the first spatial tracker and the second spatial tracker to a number of shared visible images of t the first spatial tracker and the second spatial tracker;
in response to at least a first preset proportion of Gaussian points in a spatial tracker participating in rasterization of a pixel of another first image, and the other first image being different from the first image from which the two-dimensional mask corresponding to the spatial tracker originates, the other first image is a visible image of the spatial tracker;
in response to at least a second preset proportion of Gaussian points in a spatial tracker appearing in another spatial tracker, the first image from which the two-dimensional mask corresponding to the other spatial tracker originates is containing image of the spatial tracker, and the first image from which the two-dimensional mask corresponding to the other spatial tracker originates is different from the first image from which the two-dimensional mask corresponding to the spatial tracker originates; and
the second threshold is not less than 0.8 and less than 1, the second preset proportion is greater than the first preset proportion, and the second preset proportion is greater than 50%.

20. The non-transitory computer-readable storage medium of claim 19, wherein
in response to a spatial tracker having same Gaussian points as at least two other spatial trackers, the spatial tracker always participating in rasterization of pixels of visible images of the at least two other spatial trackers, the first image from which the two-dimensional mask corresponding to the spatial tracker originates being different from the first images from which the two-dimensional masks corresponding to the at least two other spatial trackers originate, and the two-dimensional masks corresponding to the at least two other spatial trackers originating from a same first image, the two-dimensional mask corresponding to the spatial tracker is discarded.
